(19) United States
(12) Patent Application Publication
(10) Pub. No.: US 2006/0095191 A1
(43) Pub. Date: May 4, 2006

(54) Non-mechanical module for estimation of pedalling torque and consumed energy of bicycler

(76) Inventor: Chiu-Feng Lin, Pingtun (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(21) Appl. No.: 11/038,912

(22) Filed: Jan. 20, 2005

(30) Foreign Application Priority Data
Oct. 28, 2004 (TW) 093132683

(51) Int. Cl. G06F 17/00

(52) U.S. Cl. 701/84; 701/79

(57) ABSTRACT

The present invention discloses a non-mechanical module for estimation of pedaling torque and consumed energy of bicycler and also for tracking control of an electrical bicycle speed, which utilizes the measured bicycle speed, slope and motor output torque to estimate the pedaling torque applied by the bicycler, the consumed energy of the bicycler, and to determine the torque needing to be output by the motor in order to perform the tracking control of the electrical bicycle speed. The non-mechanical module for estimation of pedaling torque and consumed energy of bicycler of the present invention comprises: an estimation program package, a bicycle speed sensor, and a slope sensor, and if it is utilized in the electrical bicycle, a motor torque sensor is needed additionally. The estimation program package is embedded inside a single-chip microprocessor. The single-chip micropressor receives the measured bicycle speed, slope and motor output torque, and after calculation, outputs the estimated pedaling torque, which can be utilized to determine the torque needing to be output by the motor of the electrical bicycle. Further, via multiplying the bicycle speed, the estimated pedaling torque can be utilized to calculate the output power of the bicycler, and the energy consumed by the bicycler can thus be obtained. Furthermore, if the control object of the single-chip microprocessor is the current bicycle speed, the estimated motor torque can be utilized in the tracking control of the electrical bicycle.

### BACKGROUND OF THE INVENTION

1. Field of the Invention

The present invention relates to a module for estimation of pedalling torque and consumed energy of bicycler, particularly to a non-mechanical module for estimation of pedalling torque and consumed energy of bicycler, which utilizes the measured bicycle speed, slope, and motor output torque to estimate the pedalling torque of bicycle and the consumed energy of bicycler.

2. Description of Related Art

To meet the demand for diversified functions of the bicycle, the electrically-assisted bicycle has become a major study subject of the bicycle manufacturer, and the pedaling torque sensor, which receives the sensed pedalling torque such that an on board intelligent module can determine the amount of motor torque output to assist the bicycler, is one of the key components of the electrical bicycle.

The conventional technology of the pedalling torque sensor, such as Japan Patent No.5-246377, No.5-310177, and Taiwan Patent No. 453317, No. 288427, No. 325034, is primarily of linkage mechanism, which converts the pedalling torque generated by the human into a linear or angular displacement proportionally, which is then further converted into a proportional voltage signal by a displacement sensor.

The prior arts mentioned above are all mechanical mechanisms, and assembly of such a mechanical mechanism takes extra time for the bicycle production. Besides, adding a torque sensor on to a bicycle raises the bicycle cost. Therefore, the present invention provides a non-mechanical module for estimation of pedalling torque in order to solve the aforementioned problems.

### SUMMARY OF THE INVENTION

The objective of the present invention is to provide a non-mechanical module for estimation of pedalling torque and consumed energy of bicycler for a man-powered bicycle, wherein the measured bicycle speed and slope is utilized to estimate the pedalling torque and the consumed energy of the bicycler.

Another objective of the present invention is to provide a non-mechanical module for estimation of pedalling torque and consumed energy of bicycler for a electrical bicycle, wherein the measured bicycle speed, slope, and motor output torque is utilized to estimate the pedalling torque and the consumed energy of the bicycler.

To achieve the aforementioned objectives, the non-mechanical module for estimation of pedaling torque and consumed energy of bicycler of the present invention comprises an estimation program package embedded inside a single-chip microprocessor, a bicycle speed sensor, a slope sensor and a motor torque sensor, and the estimation program package further comprises: a feed-forward control program, a feed-back control program, a bicycle dynamics calculation program, a pedal torque calculation program, and a bicycler consumed energy calculation program, wherein with the preset parameters, such as rear wheel radius, mass of the bicycle and bicycler, gear ratio of the transmission, effective moment of inertia at the rear wheel, aero drag coefficient, and rolling resistance coefficient, and with the input variables, such as slope of the real bicycle position, forward speed of the real bicycle, and motor torque on the real bicycle, the feed-forward control program and the feed-back control program can provide a tracking control of the bicycle speed and output the results thereof to the bicycle dynamics calculation program, and the bicycle dynamics calculation program receives the outputs of the feed-forward control program and the feed-back control program and simulates the bicycle speed change under the action of the external forces and feeds the result back to the feed-back control program, and when the simulated speed worked out by the bicycle dynamics calculation program is the same as the object speed, i.e. the measured speed of the real bicycle, the results worked out by the feed-forward control program and the feed-back control program can represent the external forces acting on the bicycle and can be utilized by the pedal torque calculation program to calculate the estimated pedaling torque of the bicycler, and with the calculation result of the pedal torque calculation program, the bicycler consumed energy calculation program can work out the power output by the bicycler and the energy consumed by the bicycler, and further, the estimated pedaling torque of the bicycler can be utilized to determine the corresponding torque the motor needs to output. Furthermore, the estimation program package can be specifically designed to be a dedicated integrated circuit.

### BRIEF DESCRIPTION OF DRAWINGS

FIG. 1 is a schematic block diagram of the system architecture of the present invention.

FIG. 2 is a diagram showing the measured bicycle speed in the verification test of simulation for the present invention.

FIG. 3 is a diagram showing the estimated pedaling torque of the bicycler assuming no dynamics variable measurement error in the verification test of simulation for the present invention.

FIG. 4 is a diagram showing the torque estimation error assuming no dynamics variable measurement error in the verification test of simulation for the present invention.

FIG. 5 is a diagram showing the estimated consumed energy of the bicycler assuming no dynamics variable measurement error in the verification test of simulation for the present invention.

### PREFERRED EMBODIMENTS OF THE INVENTION

Via the detailed description of the preferred embodiments in cooperation with the attached drawings, the objectives, technical contents, characteristics and accomplishments of the present invention is to be more easily understood.

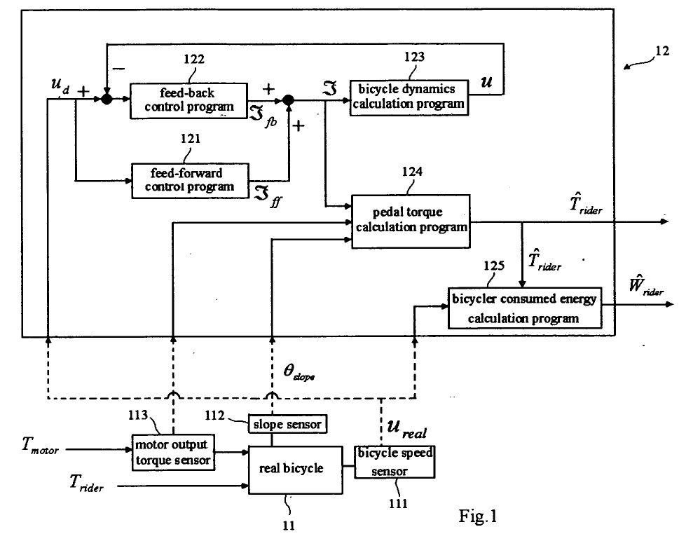

Refer to FIG. 1, a schematic block diagram of the system architecture of the present invention, wherein the block 11 represents a real bicycle and the estimation program package 12 represents a single-chip microprocessor 12 of the present invention, which further comprises: a feed-forward control program represented by the block 121, a feed-back control program represented by the block 122, a bicycle dynamics calculation program represented by the block 123, a pedal torque calculation program represented by the block 124, and a bicycler consumed energy calculation program represented by the block 125 that are all embedded inside the single-chip microprocessor 12. A bicycle speed sensor 111, a slope sensor 112, and a motor output torque sensor 113 are installed on the real bicycle 11. The signals output by those sensors are represented by the dashed lines and transferred to the single-chip microprocessor 12 via an AD/DA interface. When the module of the present invention is utilized in a man-powered bicycle, the motor output torque sensor 113 will be omitted.

The feed-forward and feed-back control algorithms are to generate a control effort so that the simulated bicycle speed can track the measured real bicycle speed. Then, the control effort is transformed algebraically to estimate the bicycler pedaling torque.

The algorithms of those programs mentioned above are stated below:

If there is no sliding motion between the rear wheel and the ground, deduced from the Newton's principle, the dynamics of the bicycle can be described by:
(Tmotor+Trider)gᵣ−T_{eff}=J_{eff}\dot{ω}_{w}u=r_{w}ω_{w} (1)
wherein Tₘₒₜₒᵣ is motor output torque;

T_{rider} pedalling torque generated by the bicycler;

gᵣ gear ratio of the transmission device;

T_{eff} effective road loading on the rear wheel;

J_{eff} effective moment of inertia at the rear wheel;

ω_{w} rear wheel speed;

u simulated bicycle speed in the estimation module;

r_{w} rear wheel radius.

The effective road loading mentioned above can be expressed as:
T_{eff}=Tᵣ+r_{w}F_{g}+r_{w}Fₐ, (2)
wherein F_{g} is slope resistance,

Fₐ aero drag,

Tᵣ rolling resistance,

and the slope resistance, the aero drag, and the rolling resistance can be further respectively expressed as:
F_{g}=mₛg sin θₛₗₒₚₑ, (3)
Fₐ=Cₐu², (4)
Tᵣ=r_{w}μmₛg cos θₛₗₒₚₑ, (5)
wherein mₛ is mass of the bicycle and bicycler,

g gravity coefficient,

θₛₗₒₚₑ slope of the real bicycle position,

Cₐ aero drag coefficient,

μ rolling resistance coefficient;

therefore, the effective road loading is obtained by inserting the above three equations into equation (2), and the result is
T_{eff}=r_{w} μmₛg cos θₛₗₒₚₑ+r_{w}mₛg sin θₛₗₒₚₑ+r_{w}cₐ(r_{w}ω_{w})². (6)

The effective moment of inertia at the rear wheel can be expressed as:
J_{eff}=J_{w}+r_{w}²mₛ, (7)
wherein J_{w} is rear wheel moment of inertia.

If equation (6) and (7) are plugged into equation (1), the results is

$$( {T}_{motor} + {T}_{rider} ) {g}_{r} - ( {r}_{w} μ {m}_{s} g cos {θ}_{slope} + {r}_{w} {m}_{s} g sin {θ}_{slope} ) = \frac{{J}_{eff}}{{r}_{w}} \dot{u} + {r}_{w} {c}_{a} {u}^{2} , \qquad ( 8 )$$

wherein (Tₘₒₜₒᵣ+T_{rider})gᵣ can be looked as the dynamic input of the bicycle and (r_{w}μmₛg cos θₛₗₒₚₑ+r_{w}mₛg sin θₛₗₒₚₑ) can be looked as the dynamic disturbance.

Subsequently, if a variable ℑ is established such that
ℑ=(Tₘₒₜₒᵣ+T_{rider)}gᵣ−(r_{w}μmₛg cos θₛₗₒₚₑ+r_{w}mₛg sin θₛₗₒₚₑ); (9)
then, equation (8) is simplified into

$$\begin{matrix}𝔍 = \frac{{J}_{eff}}{{r}_{w}} \dot{u} + {r}_{w} {c}_{a} {u}^{2} \\ = {J}_{eff} {\dot{ω}}_{w} + {r}_{w}^{3} {c}_{a} {ω}_{w}^{2}\end{matrix} \qquad ( 10 )$$

which is the differential equation used in the bicycle dynamics calculation program 123 for dynamic simulation of the bicycle.

A feed-forward control program 121 and a feed-back control program 122 are then developed to generate ℑ such that u=r_{w}ω_{w} can track the measured real bicycle speed, uᵣₑₐₗ. In other words, the measured bicycle speed is the tracking object of the control program u_{d} (control object in the program 121, 122), i.e. u_{d}=uᵣₑₐₗ. In this situation, ℑ is used in the following equation to calculate bicycler pedaling torque

$${\hat{T}}_{rider} = \frac{1}{{g}_{r}} ( 𝔍 - {T}_{motor} {g}_{r} + {r}_{w} μ {m}_{s} g cos {θ}_{slope} + {r}_{w} {m}_{s} g sin {θ}_{slope} ) , \qquad ( 11 )$$

which is derived from equation (9), wherein \hat{T}_{rider} is the estimated pedaling torque; the pedal torque calculation program 124 is designed according to equation (11).

As shown in FIG. 1, ℑ is the summation of ℑ_{ff} (obtained by the feed-forward control program 121) and ℑ_{fb} (obtained by the feed-back control program 122); thus
□ℑ=ℑ_{ff}ℑ_{fb}.

As shown in FIG. 1, the tracking object of the control program is the measured bicycle speed u_{d}. Suppose the tracking object is constant, i.e. \dot{u}_{d}=0. Besides, assume the deviation of the current simulated speed from the desired speed is Δu, i.e. u=u_{d}+Δu. Then, equation (10) is can be rearranged into

$$\begin{matrix}𝔍 = {𝔍}_{ff} + {𝔍}_{fb} \\ = \frac{{J}_{eff}}{{r}_{w}} Δ \dot{u} + {r}_{w} {{c}_{a} ( {u}_{d} + Δ u )}^{2} \\ = {J}_{eff} Δ {\dot{ω}}_{w} + {r}_{w} {{c}_{a} ( {r}_{w} {ω}_{wd} + {r}_{w} Δ {ω}_{w} )}^{2} ,\end{matrix} \qquad ( 13 )$$

wherein ℑ_{ff} is a feed-forward control command and ℑ_{fb} is a feed-back control command. The above equation shows that the feed-forward control law can be scheduled as
ℑ_{ff}=r_{w}cₐu_{d}²=r_{w}³cₐω_{wd}², (14)
wherein r_{w}ω_{wd}=u_{d}. By subtracting equation (14) from equation (13), the result is

$$\begin{matrix}{𝔍}_{fb} = \frac{{J}_{eff}}{{r}_{w}} Δ \dot{u} + 2 {r}_{w} {c}_{a} {u}_{d} Δ u + {r}_{w} {c}_{a} Δ {u}^{2} \\ = {J}_{eff} Δ {\dot{ω}}_{w} + 2 {r}_{w}^{2} {c}_{a} {ω}_{wd} Δ {ω}_{w} + {r}_{w}^{3} {c}_{a} Δ {ω}_{w}^{2}\end{matrix} \qquad ( 15 )$$

The goal of the feed-back law is then to eliminate Δu to achieve u=u_{d}. The feed-back law can be designed through several different feed-back control theories and the pole-placement method is used in the present invention. To apply pole-placement method, equation (15) is linearized and the result is

$$\begin{matrix}{𝔍}_{fb} = \frac{{J}_{eff}}{{r}_{w}} Δ \dot{u} + 2 {r}_{w} {c}_{a} {u}_{d} Δ u \\ = {J}_{eff} Δ {\dot{ω}}_{w} + 2 {r}_{w}^{3} {c}_{a} {ω}_{wd} Δ {ω}_{w}\end{matrix} \qquad ( 16 )$$

Next, the feed-back law is scheduled as
ℑ_{fb}=−kΔ107 _{w}; (17)
thus, equation can be rewritten as

$$Δ {\dot{ω}}_{w} = \frac{( - 2 {r}_{w}^{3} {c}_{a} {ω}_{wd} - k )}{{J}_{eff}} Δ {ω}_{w} ; \qquad ( 18 )$$

then, appropriate k value can be used to obtain desired convergence performance.

When the estimated speed U worked out by the bicycle dynamics calculation program 123 is the same as the object speed, i.e. u=uᵣₑₐₗ, ℑ worked out by the feed-forward control program 121 and the feed-back control program 122 can be utilized to calculate the estimated pedaling torque \hat{T}_{rider} according to equation (11). When the estimated pedaling torque \hat{T}_{rider} is worked out, the power output by the bicycler \hat{P}_{rider} can be calculated as
\hat{P}_{rider}(t)=\hat{T}_{rider}(t)ω_{w}(t)gᵣ, (19)
and further the energy consumed by the bicycler can be calculated as

$${\hat{W}}_{rider} ( t ) = {\int }_{0}^{t} {\hat{P}}_{rider} ( λ ) ⅆ λ . \qquad ( 20 )$$

To validate the estimation algorithm and study the performance of the estimation, a Simulink simulation code is developed and several different simulations are conducted. The results are discussed in below.

In the Simulink simulation code, a bicycle dynamics block is developed to simulate the forward speed of a MERIDA PC 400 electrical bicycle under the actuation of bicycler pedaling torque, motor torque and road loads. The specification of MERIDA PC 400 is listed in Table. 1.

TABLE 1
Specification of MERIDA PC 400

| | | |
|---|---|---|
| Weight | 40 | kgw |
| Gear ratio | 3.0 | |
| Rear wheel radius | 0.33 | m |
| Rear wheel weight | 0.0118 | kgw |
| Aero drag coefficient | 0.328 | |
| Rolling resistance | 0.01 | |
| coefficient | | |

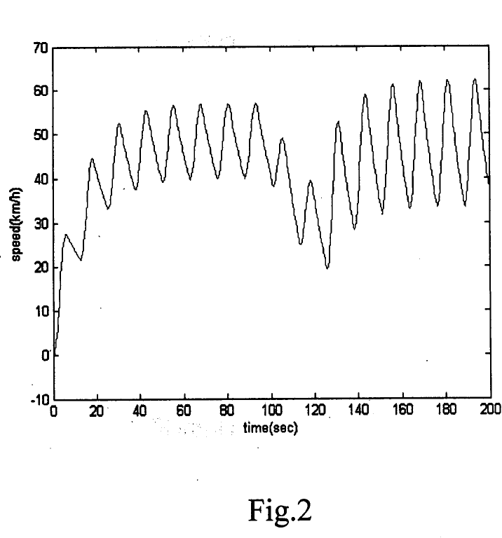

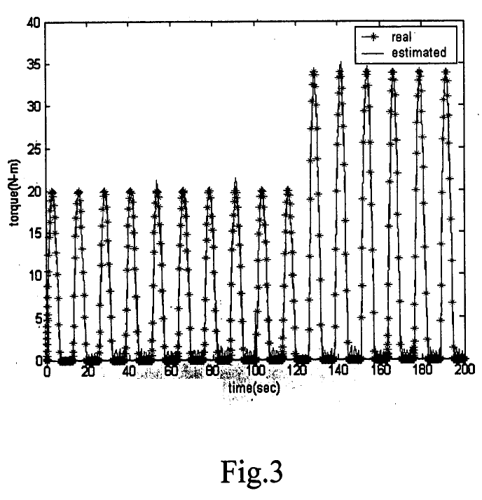

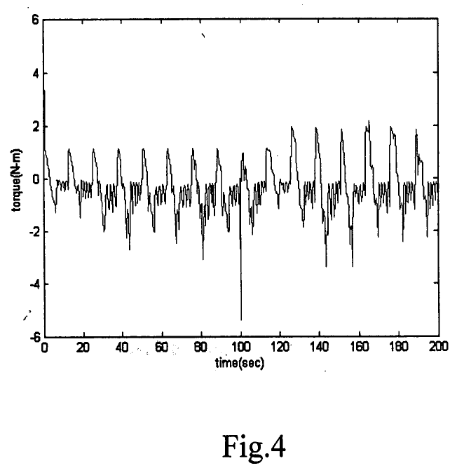

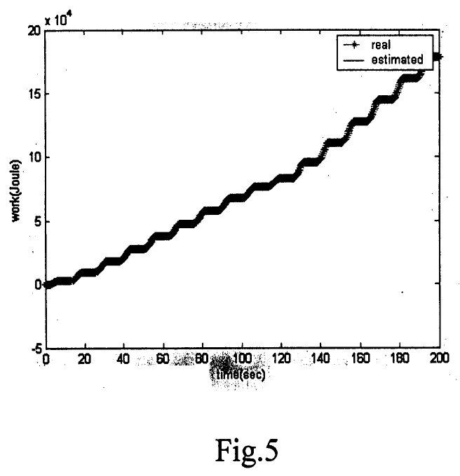

The first simulation with the Simulink code is to validate the proposed estimation algorithm. In the simulation, the bicycle is driven on a flat surface and then meets a slope at 100 second. The bicycler then raises the pedaling torque to maintain the same speed. In the simulation, the slope, the motor torque, and bicycle speed are assumed perfectly measured. The bicycler pedaling torque features an amplitude of 20 N-m initially and 34 N-m after 120 second and a frequency of 0.5 rad/sec. The pedaling torque is a half-wave function, which mimics the real human pedaling; the torque is zero in between the positive wave. The desired estimation convergence rate (i.e. the desired close loop pole) is designed as 0.1 second. The speed of the bicycle is shown in FIG. 2, the measured torque is shown in FIG. 3, the estimation error is shown in FIG. 4, and the bicycler consumed energy measured is shown in FIG. 5. FIG. 2 shows that the bicycle speed rises to a stable speed range on flat road. At 100 second, the bicycle speed slows down due to slope and the speed rises again at 120 second due to the enlargement of the pedaling torque. FIG. 3 shows that the measured torque can track the real torque satisfactorily. FIG. 4 shows that the peak value of the tracking error is about 7% the peak value of real torque except at 100 sec and 120 sec. where the bicycle dynamics has a dramatic change inducing a substantial estimation error. If the tracking is discussed in term of the ratio between the torque track error and the real torque value, the average value of this ratio is −0.0012 and the relative standard deviation is 0.0526. Finally, FIG. 5 reveals that the estimated bicycler consumed energy follows the real consumed energy closely. The maximum estimation error is 1.25% the real consumed energy. Thus, it is acceptable in the real application since this amount of error is usually ignored for a normal person in exercise.

Beside the above simulation, several other similar simulations with differences in pedaling torque frequency and designed observation convergence rate are also conducted. It is noticed that appropriate convergence rate must be chosen with respect to the variation of pedaling torque frequency; a fast convergence rate tends to increase the error bias and a slow convergence rate tends to increase the error peak. Thus, for the real application, adaptive law must be developed to adjust the feed-back loop gain in real time. It is also noticed that the nominal speed for the calculation of close loop gain in equation (20) has little effect on the estimation performance. Thus, a fixed nominal speed can be used for the close loop gain design.

Next, the sensitivity of the estimation error with respect to the parameter deviation of the dynamics model in the estimation module from the real bicycle values is also studied. In each simulation, simulation conditions are the same as that in the previous simulations with the exception that one parameter value deviates from the real value for 10%. The maximum torque tracking error, average value of the torque tracking error, and standard deviation of the torque tracking error are recorded for each simulation. The results are shown in Table.2. Table.2 reveals that the ratio between peak values of the torque estimation error and the real torque are similar to the previous result. Furthermore, the average value and standard deviation of the ratios do not change significantly. Thus, a 10% deviation of the system parameter identification error is allowable for this purpose for the average performance.

TABLE 2
Torque Tracking Errors With Respect To Parameter Value Deviations

| Parameters | ρₚ | ρ_{avg} | ρ_{std} |
|---|---|---|---|
| No parameter | 0.07 | −0.0012 | 0.0526 |
| deviation | | | |
| Bicycle and bicycler | 0.07 | −0.0124 | 0.0476 |
| mass deviation | | | |
| Aero drag | 0.07 | −0.0139 | 0.0750 |
| coefficient | | | |
| Rolling resistance | 0.07 | −0.0057 | 0.0684 |
| coefficient | | | |

Finally, the effects of the measurement errors of the motor torque, slope, and bicycle speed on the estimation performance are studied. This issue is studied by adding a white noise to the measurements. The standard deviations of the white noises are set to be 5% the peak value of each variable measurement. The results are included in Table.3. The results show that the motor torque measurement noise and slope measurement noise do not introduce significant values on the torque tracking error. However, bicycle speed measurement error has significant effect on the result. Therefore, an appropriate filter is required to eliminate the relative measurement noise. For the real application, the filter design can be accomplished via collecting the measurement and identifying the spectrum of the measurement noise. Then, a band-limited filter can be designed.

TABLE 3
Torque Tracking Errors With Respect To Measurement Noise

| Parameters | ρₚ | ρ_{avg} | ρ_{std} |
|---|---|---|---|
| No | 0.07 | −0.0012 | 0.0526 |
| measurement | | | |
| noise | | | |
| Motor torque | 0.07 | 0.0039 | 0.0597 |
| Slope | 0.07 | 0.0035 | 0.0604 |
| Bicycle speed | 1.00 | −1.0152 | 3.6298 |

Simulation results show that the torque estimation can track the real torque satisfactorily. Under the case of no measurement noise and no parameter value deviation, the peak value of the tracking error is about 7% the peak value of real torque except at the point of dramatic dynamics variation. The average value of the ratio between the torque track error and the real torque value is −0.0012 and the relative standard deviation is 0.0526. Simulation results also reveal that the estimated bicycler consumed energy follows the real consumed energy closely. The maximum estimation error is 1.25% the real consumed energy.

It is also noticed that appropriate convergence rate must be chosen with respect to the variation of pedaling torque frequency. Thus, for the real application, adaptive law is suggested to adjust the feed-back loop gain in real time. It is also noticed that the nominal speed for the calculation of estimation close loop gain has little effect on the estimation performance. Thus, a fixed nominal speed can be used for the close loop gain design.

The sensitivity of the estimation error with respect to the parameter deviation of the dynamics model in the estimation module from the real bicycle values is also studied. For a 10% deviation in the parameter values, the average value and standard deviation of the ratios do not change significantly. Thus, a 10% deviation of the system parameter identification error is allowable for this purpose.

Finally, the effects of the measurement errors of the motor torque, slope, and bicycle speed on the estimation performance are studied. The results show that the motor torque measurement noise and slope measurement noise do not introduce extra values on the torque tracking error. However, bicycle speed measurement error has significant effect on the result. Therefore, an appropriate filter is required to eliminate the relative measurement noise.

It is to be emphasized that those described above are only the preferred embodiments of the present invention and not intended to limit the scope of the present invention, and any equivalent modification or variation according to the spirit of the present invention is to be included within the scope of the present invention.

What is claimed is:

1. A non-mechanical module for estimation of pedaling torque and consumed energy of bicycler, which utilizes a measured bicycle speed and a measured slope of the bicycle position to estimate the pedaling torque and the consumed energy of the bicycler of a man-powered bicycle, comprising an estimation program package embedded inside a single-chip microprocessor, a bicycle speed sensor, and a slope sensor, wherein said estimation program package further comprises:
a feed-forward control program, receiving said measured bicycle speed and outputting a feed-forward control command;
a feed-back control program, receiving said measured bicycle speed and a simulated bicycle speed, and cooperating with said feed-forward control program to enable simulated bicycle speed to equal said measured bicycle speed, and outputting a feed-back control command;
a bicycle dynamics calculation program, receiving said feed-forward control command and said feed-back control command, and simulating the bicycle speed change under the action of the feed-forward control command and said feed-back control command, and feeding said simulated bicycle speed back to said feed-back control program;
a pedal torque calculation program, when said simulated speed worked out by said bicycle dynamics calculation program is the same as said measured bicycle speed, utilizing the summation of said feed-forward control command and said feed-back control command and said measure slope of the bicycle position to work out said pedaling torque of the bicycler; and
a bicycler consumed energy calculation program, working out the power output by the bicycler and said energy consumed by the bicycler with said pedaling torque of the bicycler worked out by said pedal torque calculation program;
wherein the preset parameter values of said microprocessor include: rear wheel radius, mass of the bicycle and bicycler, gear ratio of the transmission, effective moment of inertia at the rear wheel, aero drag coefficient and rolling resistance coefficient, and the variables input into said microprocessor include: said measured slope of the bicycle position and said measured speed of the bicycle.

2. A non-mechanical module for estimation of pedaling torque and consumed energy of bicycler for a electrical bicycle, which utilizes a measured bicycle speed, a measured slope of the bicycle position and a measured torque output by an electrical bicycle's motor to estimate the pedaling torque and the consumed energy of the bicycler and perform the tracking control of an electrical bicycle, comprising an estimation program package embedded inside a single-chip microprocessor, a bicycle speed sensor, a slope sensor, and motor torque sensor, wherein said estimation program package further comprises:
a feed-forward control program, receiving said measured bicycle speed and outputting a feed-forward control command;
a feed-back control program, receiving said measured bicycle speed and a simulated bicycle speed, and cooperating with said feed-forward control program to enable simulated bicycle speed to equal said measured bicycle speed, and outputting a feed-back control command;
a bicycle dynamics calculation program, receiving said measured bicycle speed, said feed-forward control command and said feed-back control command, and simulating the bicycle speed change under the action of feed-forward control command and said feed-back control command, and feeding said simulated bicycle speed back to said feed-back control program;
a pedal torque calculation program, when said simulated speed worked out by said bicycle dynamics calculation program is the same as said measured bicycle speed, utilizing the summation of said feed-forward control command and said feed-back control command, said measure slope of the bicycle position and said measured torque output by an electrical bicycle's motor to work out said pedaling torque of the bicycler; and
a bicycler consumed energy calculation program, working out the power output by the bicycler and said energy consumed by the bicycler with said pedaling torque of the bicycler worked out by said pedal torque calculation program;
wherein said estimated pedaling torque of the bicycler can be utilized to determine the corresponding torque said motor needs to output so that the speed of said electrical bicycle can be maintained; the preset parameter values of said microprocessor include: rear wheel radius, mass of the bicycle and bicycler, gear ratio of the transmission, effective moment of inertia at the rear wheel, aero drag coefficient and rolling resistance coefficient, and the variables input into said microprocessor include: said measured slope of the bicycle position, said measured speed of the bicycle and said measured torque output by an electrical bicycle's motor.

3. A single-chip microprocessor for estimation of pedaling torque and consumed energy of bicycler, which utilizes a measured bicycle speed and a measured slope of the bicycle position to estimate the pedaling torque and the consumed energy of the bicycler of a man-powered bicycle, comprising an estimation program package that further comprises:
a feed-forward control program, receiving said measured bicycle speed and outputting a feed-forward control command;
a feed-back control program, receiving said measured bicycle speed and a simulated bicycle speed, and cooperating with said feed-forward control program to enable simulated bicycle speed to equal said measured bicycle speed, and outputting a feed-back control command;
a bicycle dynamics calculation program, receiving said measured bicycle speed, said feed-forward control command and said feed-back control command, and simulating the bicycle speed change under the action of the external forces, and feeding said simulated bicycle speed back to said feed-back control program;
a pedal torque calculation program, when said simulated speed worked out by said bicycle dynamics calculation program is the same as said measured bicycle speed, utilizing the summation of said feed-forward control command and said feed-back control command, and said measure slope of the bicycle position to work out said pedalling torque of the bicycler; and
a bicycler consumed energy calculation program, working out the power output by the bicycler and said energy consumed by the bicycler with said pedalling torque of the bicycler worked out by said pedal torque calculation program;
wherein said estimation program package is embedded inside a single-chip microprocessor; the preset parameter values of said microprocessor include: rear wheel radius, mass of the bicycle and bicycler, gear ratio of the transmission, effective moment of inertia at the rear wheel, aero drag coefficient and rolling resistance coefficient, and the variables input into said microprocessor include: said measured slope of the bicycle position and said measured speed of the bicycle.

4. A single-chip microprocessor for tracking control of electrical bicycle speed and estimation of pedalling torque and consumed energy of bicycler, which utilizes a measured bicycle speed, a measured slope of the bicycle position and a measured torque output by an electrical bicycle's motor to estimate the pedalling torque and the consumed energy of the bicycler and perform the tracking control of an electrical bicycle, comprising an estimation program package that further comprises:
a feed-forward control program, receiving said measured bicycle speed and outputting a feed-forward control command;
a feed-back control program, receiving said measured bicycle speed and a simulated bicycle speed, and cooperating with said feed-forward control program to enable simulated bicycle speed to equal said measured bicycle speed, and outputting a feed-back control command;
a bicycle dynamics calculation program, receiving said measured bicycle speed, said feed-forward control command and said feed-back control command, and simulating the bicycle speed change under the action of the external forces, and feeding said simulated bicycle speed back to said feed-back control program;
a pedal torque calculation program, when said simulated speed worked out by said bicycle dynamics calculation program is the same as said measured bicycle speed, utilizing the summation of said feed-forward control command and said feed-back control command, said measure slope of the bicycle position and said measured torque output by an electrical bicycle's motor to work out said pedalling torque of the bicycler; and
a bicycler consumed energy calculation program, working out the power output by the bicycler and said energy consumed by the bicycler with said pedalling torque of the bicycler worked out by said pedal torque calculation program;
wherein said estimation program package is embedded inside a single-chip microprocessor; said estimated pedaling torque of the bicycler can be utilized to determine the corresponding torque said motor needs to output so that the speed of said electrical bicycle can be maintained; the preset parameter values of said microprocessor include: rear wheel radius, mass of the bicycle and bicycler, gear ratio of the transmission, effective moment of inertia at the rear wheel, aero drag coefficient and rolling resistance coefficient, and the variables input into said microprocessor include: said measured slope of the bicycle position, said measured speed of the bicycle and said measured torque output by an electrical bicycle's motor.

5. The single-chip microprocessor for estimation of pedaling torque and consumed energy of bicycle according to claim 3, wherein said single-chip microprocessor is further integrated with a bicycle speed sensor and a slope sensor to form a module.

6. The single-chip microprocessor for estimation of pedaling torque and consumed energy of bicycle according to claim 4, wherein said single-chip microprocessor is further integrated with a bicycle speed sensor, a slope sensor and a motor torque sensor to form a module.

7. The single-chip microprocessor for estimation of pedaling torque and consumed energy of bicycle according to claim 3, wherein the basic operation logics of said estimation program package is to measure the speed of the real bicycle and set said measured real bicycle speed as the control object and enable the simulated speed to equal said measured real bicycle speed.

8. The single-chip microprocessor for estimation of pedaling torque and consumed energy of bicycle according to claim 4, wherein the basic operation logics of said estimation program package is to measure the speed of the real bicycle and set said measured real bicycle speed as the control object of the feed-forward and feed-back control algorithm and enable the simulated speed to equal said measured real bicycle speed.

9. The single-chip microprocessor for estimation of pedalling torque and consumed energy of bicycle according to claim 3, wherein said feed-back control program can be designed using all the feed-back control theories such as the pole-placement method, optimal control theory etc.

10. The single-chip microprocessor for estimation of pedalling torque and consumed energy of bicycle according to claim 4, wherein said feed-back control program can be designed using all the feed-back control theories such as the pole-placement method, optimal control theory etc.

11. The single-chip microprocessor for estimation of pedaling torque and consumed energy of bicycle according to claim 9, wherein an appropriate convergence rate is chosen according to the variation of pedaling torque frequency.

12. The single-chip microprocessor for estimation of pedaling torque and consumed energy of bicycle according to claim 10, wherein an appropriate convergence rate is chosen according to the variation of pedaling torque frequency.

13. The single-chip microprocessor for estimation of pedaling torque and consumed energy of bicycle according to claim 3, wherein an appropriate filter is installed to eliminate the relative measurement noise.

14. The single-chip microprocessor for estimation of pedaling torque and consumed energy of bicycle according to claim 4, wherein an appropriate filter is installed to eliminate the relative measurement noise.

15. The single-chip microprocessor for estimation of pedaling torque and consumed energy of bicycle according to claim 3, wherein an appropriate convergence rate is chosen according to the variation of pedaling torque frequency.

16. The single-chip microprocessor for estimation of pedaling torque and consumed energy of bicycle according to claim 4, wherein an appropriate convergence rate is chosen according to the variation of pedaling torque frequency.

17. The single-chip microprocessor for estimation of pedaling torque and consumed energy of bicycle according to claim 3, wherein said estimation program package is specifically designed to be a dedicated integrated circuit.

18. The single-chip microprocessor for estimation of pedaling torque and consumed energy of bicycle according to claim 4, wherein said estimation program package is specifically designed to be a dedicated integrated circuit.
